(19) United States
(12) Patent Application Publication
(10) Pub. No.: US 2010/0196865 A1
(43) Pub. Date: Aug. 5, 2010

(54) FLUID DELIVERY SYSTEM FOR PATIENT SIMULATION MANIKIN

(75) Inventors: John A. KAYS, Palymyra, PA (US); David William DRUMHELLER, Dornsife, PA (US)

Correspondence Address: Pepper Hamilton LLP, 400 Berwyn Park, 899 Cassatt Road, Berwyn, PA, 19312-1183, US

(73) Assignee: PINNACLE HEALTH HOSPITALS, Harrisburg, PA (US)

(21) Appl. No.: 12/366,454

(22) Filed: Feb. 5, 2009

(51) Int. Cl. G09B 23/32

(52) U.S. Cl. 434/268

(57) ABSTRACT

A fluid delivery system for remotely controlling the flow of simulated bodily fluids to a patient simulation manikin. The fluid delivery system may include multiple reservoirs for holding the simulated bodily fluids and multiple valves for controlling the flow of the simulated bodily fluids from the reservoirs to the manikin. The fluid delivery system may also include a fluid delivery component, such as a compressor or pump, for causing the simulated bodily fluids to flow from the reservoirs to the manikin. The reservoirs, the fluid delivery component, the valves, and the manikin may be interconnected to one another via tubing. The fluid delivery system may be controlled remotely from the manikin so that a trainee is not able to anticipate when the simulated bodily fluids will be delivered to and/or discharged from the manikin. The simulated bodily fluids may be delivered to the patient simulation manikin simultaneously and/or successively.

### TECHNOLOGY FIELD

The present disclosure generally relates to fluid delivery systems, and more particularly, to a fluid delivery system for remotely controlling the flow of simulated bodily fluids to a patient simulation manikin. The disclosed embodiments are particularly well suited for, but not limited to, medical training exercises.

### BACKGROUND

Patient simulation manikins may be used to train medical service providers, such as physicians, residents, interns, medical students, nurses, nursing students, EMT/paramedics, respiratory therapists, etc., on how to properly treat injured individuals during emergency situations. The patient simulation manikins may include various types of simulated injuries. For example, a patient simulation manikin may be used to imitate a fractured leg or severe lacerations.

Simulated blood may also be used with the patient simulation manikin to provide a more realistic training environment. For example, the simulated blood may be placed in or around a simulated wound. Moreover, the simulated blood may be stored in a syringe, which may be connected to tubing that extends to the patient simulation manikin. The tubing may be connected to a wound in the patient simulation manikin. Thus, during a training exercise, a trainer may manually squeeze a bulb on the syringe to push the simulated blood into the patient simulation manikin. The simulated blood may then be released from the wound, thereby providing a more realistic simulation.

Currently, the syringe used by the trainer is generally located at the patient simulation manikin. As such, the trainer must also be positioned at the patient simulation manikin to deliver the simulated blood to the patient simulation manikin during the training exercise. The trainee is, therefore, generally able to anticipate when the simulated blood will be discharged from the patient simulation manikin by observing the actions of the trainer. The trainee's ability to anticipate a simulated patient response (e.g., the discharge of simulated blood from a wound) reduces the effectiveness of the training exercise because it eliminates the element of surprise, which is generally a desired characteristic of most medical training exercises.

### SUMMARY

The disclosed embodiments include a fluid delivery system for remotely controlling the flow of simulated bodily fluids to a patient simulation manikin. The fluid delivery system and the patient simulation manikin may be part of a medical training system that is used to implement training exercises for medical service providers. Remote control of the fluid delivery system enhances the training exercise by helping to create the element of surprise and the suspension of disbelief, i.e., suspend a trainee's belief that the simulated medical condition or emergency is not real.

The fluid delivery system may include the ability to deliver multiple and different fluids to the patient simulation manikin simultaneously. The fluid delivery system may include multiple reservoirs for holding the simulated bodily fluids and multiple valves for controlling the flow of the simulated bodily fluids from the reservoirs. The flow of the simulated bodily fluids may be controlled remotely from the patient simulation manikin so that a trainee is not able to anticipate when or where the simulated bodily fluids will be delivered to the patient simulation manikin. The fluid delivery system may also include a fluid delivery component, such as a compressor or pump, for causing the simulated bodily fluids to flow from the reservoirs to the patient simulation manikin. The reservoirs, fluid delivery component, and valves may be interconnected to one another via tubing. Moreover, the reservoirs, fluid delivery component, valves and/or tubing may each be disposed remotely from the patient simulation manikin.

In another embodiment, the fluid delivery system may provide for automatic or electronic control of the flow of simulated bodily fluids to the patient simulation manikin. For example, an electronic controller may control one or more of the fluid delivery component and/or the valves to produce a flow of fluid to the patient simulation manikin.

Additional features and advantages of the disclosed embodiments will be made apparent from the following detailed description of illustrative embodiments that proceeds with reference to the accompanying drawings.

### BRIEF DESCRIPTION OF THE DRAWINGS

The foregoing and other aspects of the disclosed embodiments will be better understood from the following detailed description with reference to the drawings.

FIGS. 1-4 are graphical representations of a patient simulation manikin connected to an exemplary fluid delivery system;

FIGS. 5-9 are system diagrams of exemplary embodiments of the fluid delivery system shown in FIGS. 1-4;

FIG. 10 is a flow diagram depicting an exemplary method for remotely controlling the flow of simulated bodily fluids to the patient simulation manikin; and

FIGS. 11 and 12 are flow diagrams of exemplary predetermined training scenarios.

### DETAILED DESCRIPTION OF ILLUSTRATIVE EMBODIMENTS

The disclosed embodiments may be used to train medical service providers (e.g., doctors, nurses, medical students, paramedics, etc.) how to manage various real-life clinical scenarios by simulating the physiology, and the physiological responses, of an inured human or animal. In particular, the disclosed embodiments may include a medical training system having a fluid delivery system and a patient simulation manikin. The patient simulation manikin may be an anatomical model of a human (e.g., baby, child, or adult) or animal. The medical training system may also include an injury overlay kit, which may include cosmetic make-up, pre-formed wounds, and/or pre-formed artificial skin that may be attached to the patient simulation manikin to simulate various types of injuries.

The fluid delivery system may be used to control the delivery of multiple types of simulated bodily fluids, such as blood, sweat, vomit, tears, bile, urine, spinal fluid, stool, and the like. The fluid delivery system may be controlled remotely from the patient simulation manikin (i.e., out of the purview of a trainee), and may enable the simulated bodily fluids to be delivered to the patient simulation manikin simultaneously and/or successively. The different fluids may then be released or discharged from any wounds or openings disposed on the patient simulation manikin. As such, the fluid delivery system may dramatically increase the authenticity of the simulated injuries, thereby providing a more effective training environment.

The fluid delivery system may control the delivery of the different simulated bodily fluids to replicate desired clinical scenarios, such as a patient suffering from a gun shot wound to the chest and/or trauma to the head. For example, in one embodiment, a trainer may control the fluid delivery system to deliver simulated blood and vomit to the patient simulation manikin. The simulated blood may then be discharged from a simulated open wound on the patient simulation manikin whilst simulated vomit is simultaneously discharged from an opening in the manikin's mouth.

The delivery of the different simulated bodily fluids may also be controlled to simulate a patient's typical physiological response to a specific action taken by a trainee. For example, the trainer may control the fluid delivery system to simulate an increase in blood loss, by increasing the flow rate of the simulated blood to the patient simulation manikin, prompting the trainee to act by applying direct pressure to the simulated open wound. The fluid delivery system may control the delivery of the simulated bodily fluids either manually (e.g., based on operator action or input) or automatically (e.g., based on a computer program).

Some or all of the components of the fluid delivery system may be located remotely from the patient simulation manikin (i.e., out of the purview of the trainee) to prevent the trainee from anticipating when the simulated bodily fluids are to be delivered to the patient simulation manikin during a training exercise. For example, the components of the fluid delivery system may be located in another room that is separate from the training room, or at any location within the training room that is not readily visible to the trainee, such as under the table or bed used to support the patient simulation manikin. Thus, the trainee may not be able to foresee when or where the simulated bodily fluids are to be discharged by observing the operation of the fluid delivery system. This may facilitate the element of surprise and create, at least temporarily, the suspension of disbelief, i.e., suspend the trainee's belief that the simulated clinical scenario is not real. As such, the fluid delivery system may be used to greatly improve the trainee's learning experience.

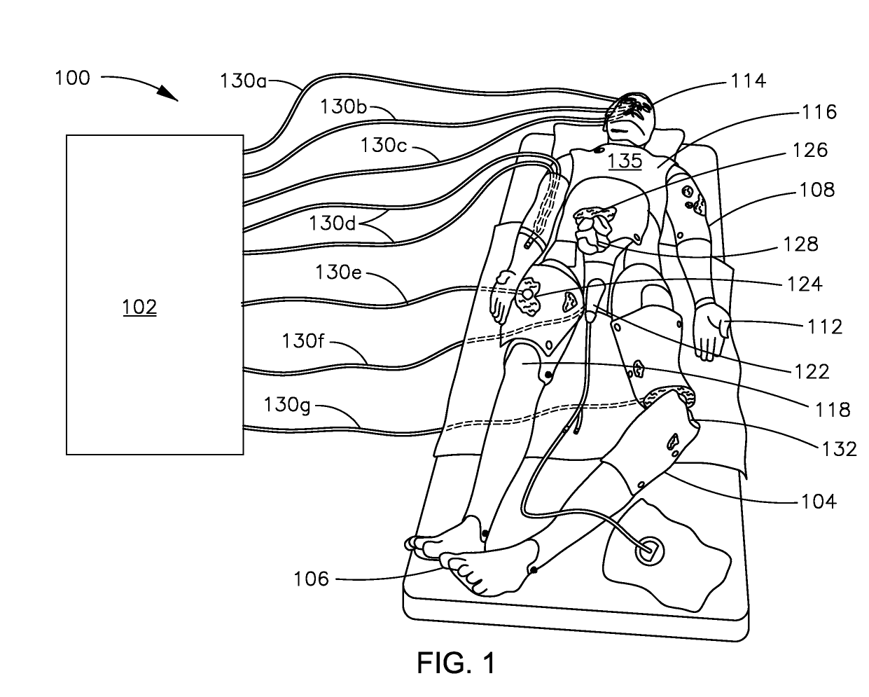

FIG. 1 shows an exemplary patient simulation manikin 135 connected to an exemplary fluid delivery system 102. The fluid delivery system 102 and the patient simulation manikin 135 may be part of a medical training system 100, which may be supplied or sold to end users as a single product. Alternatively, the fluid delivery system 102 may be supplied separately as part of a kit for upgrading an existing patient simulation manikin 135. The medical training system 100 may be used to implement training exercises that teach trainees how to properly respond to actual medical situations and emergencies.

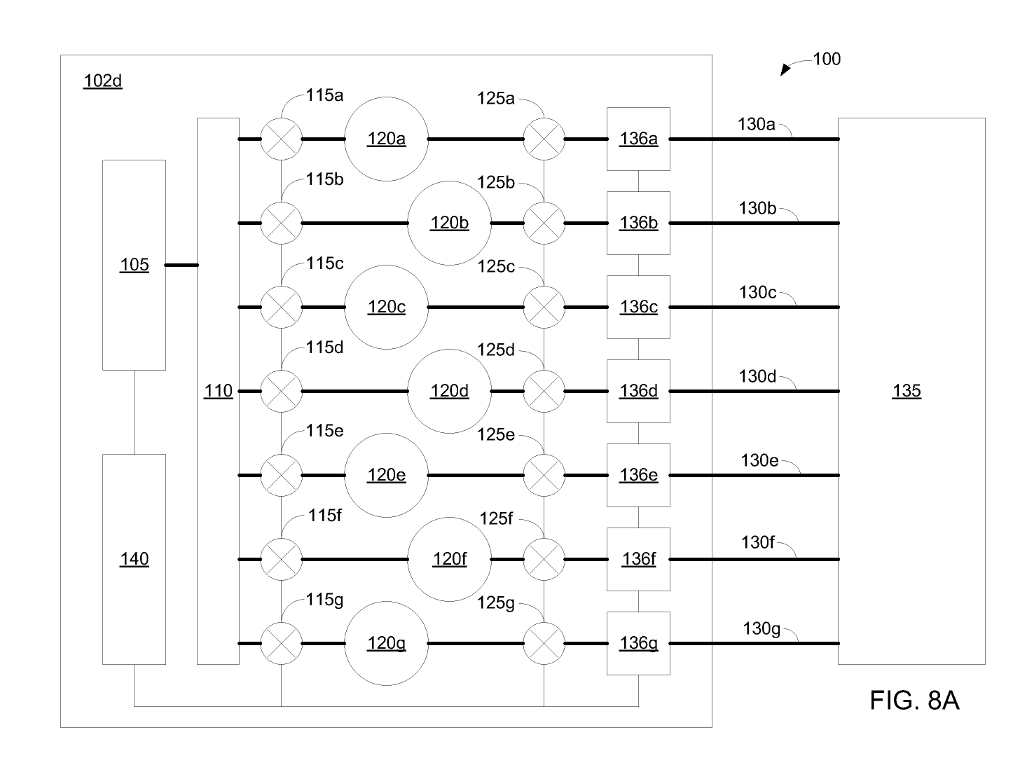

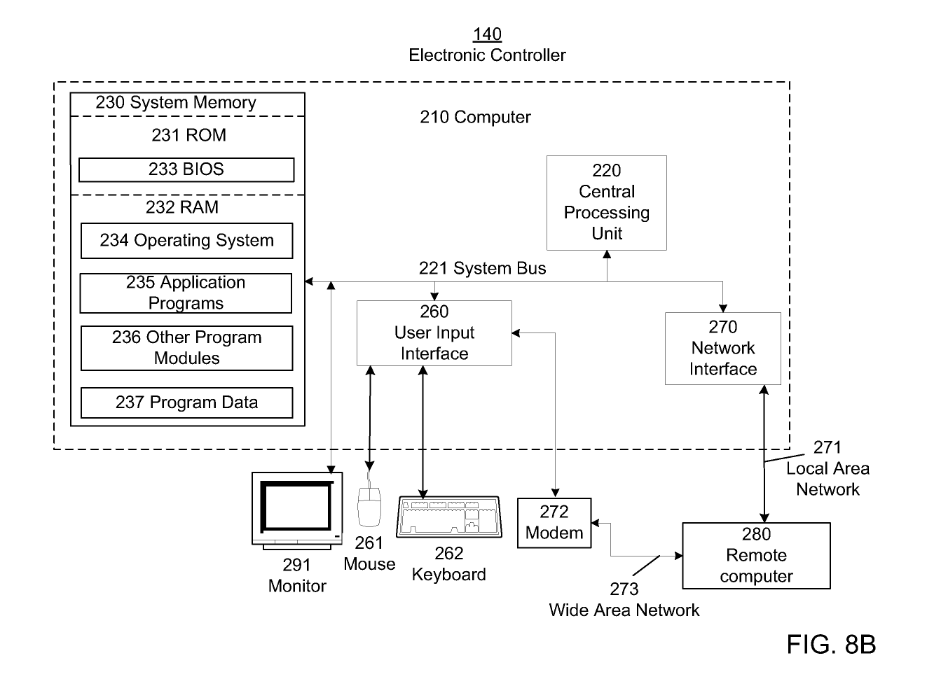

In addition to the fluid delivery system 102 and the patient simulation manikin 135, the medical training system 100 may include a recording component 148 for recording audio and video data. For example, a video camera may be set-up to record the audio and video data associated with a training exercise. The audio and video data may then be played back to a trainee at the conclusion of the training exercise so the trainee can observe and evaluate his or her performance first-hand. As discussed below, in one embodiment, the fluid delivery system 102 may include an electronic controller (see, e.g., FIGS. 8A and 8B). Thus, as shown in FIG. 1, the recording component 148 may be connected to the fluid delivery system 102, which may store the recorded audio and visual data in the electronic controller for later playback and analysis.

The patient simulation manikin 135 may be an anatomical model of some, or all, of the internal and/or external parts of a human or animal. For example, as shown in FIG. 1, the patient simulation manikin 135 may include legs 104, feet 106, arms 108, hands 112, a head 114, a torso 116, as well as other parts of the body. The patient simulation manikin 135 may also include one or more joints 118 for simulating the motion of an elbow or knee, for example. The patient simulation manikin 135 shown in FIG. 1 includes male genitalia 122, though it will be appreciated that the patient simulation manikin 135 may include female genitalia in alternative embodiments.

The patient simulation manikin 135 may simulate various types of injuries, such as wounds, lacerations, abrasions, contusions, internal bleeding, ruptured fluid sack, burns, etc., that may be received by an actual human being or animal. For example, the patient simulation manikin 135 may include one or more simulated open wounds, such as an open wound 124 in one of the legs 104 and an open wound 126 in the torso 116. The open wounds 124 and 126 may reveal simulated internal tissue or bone. The open wounds 124 and 126 may also reveal simulated internal organs, such as intestines 128. The patient simulation manikin 135 may also include a simulated amputated leg 132.

The simulated injuries may be supplied with, or sold separately from, the patient simulation manikin 135. The simulated injuries may be part of an injury overlay kit, and may be removably attached to the patient simulation manikin 135 to simulate various combinations of injuries. For example, the open wounds 124 and 126 may be supplied with the overlay kit, and may be attached to the patient simulation manikin 135 in preparation for the training exercise. Alternatively, the simulated injuries may be integral to the patient simulation manikin 135.

As noted above, the simulated injuries in the overlay kit may include cosmetic make-up, pre-formed wounds, and/or pre-formed artificial skin that may be attached to the patient simulation manikin 135. The simulated injuries in the overlay kit may be designed to simulate active or passive injuries. For example, active simulated injuries in the overlay kit may include pre-formed openings and fittings that enable them to receive and discharge simulated bodily fluids. The active simulated injuries, therefore, may be readily connected to the fluid delivery system 102.

The passive simulated injuries in the overlay kit may not include any pre-formed openings and/or fittings for receiving and discharging simulated bodily fluids. The passive simulated injuries may, nonetheless, be adapted to receive and discharge simulated bodily fluids by incorporating the appropriate fittings, and by creating the desired openings. Thus, the fluid delivery system 102 may be used in conjunction with either active or passive simulated injuries supplied in the overlay kit.

The patient simulation manikin 135 may be connected to the fluid delivery system 102 via tubing 130a-130g, which may include any suitable type of tubing for carrying liquids or gas. In one embodiment, the tubing 130a-130g may be standard intravenous tubing used in hospitals. The tubing 130a-130g may be routed from the fluid delivery system 102 to the patient simulation 135. At least a portion of the tubing 130a-130g may also be routed within the patient simulation manikin 135 to different portions of the body. The tubing 130a-130g is preferably concealed or hidden from the trainee to enhance the authenticity of the training exercise.

For example, portions of the tubing 130a-130c may be routed within the head 114 and connected to the eyes, nose, and throat/mouth, respectively. In addition, portions of the tubing 130d may be routed within one or both of the arms 108, portions of the tubing 130e and 130g may be routed within one or both of the legs 104, and portions of the tubing 130f may be routed within the genitalia 122. Thus, as will be further discussed below, the tubing 130a-130g may be used to deliver different types of simulated bodily fluids, such as blood, sweat, vomit, tears, bile, urine, spinal fluid, stool, and the like, to different portions of the patient simulation manikin 135.

Each of the simulated bodily fluids may be created to simulate the color and consistency of an actual bodily fluid of a human or animal. For example, the simulated blood may have a bright red color to simulate arterial blood or a dark red color to simulate venous blood. In addition, the simulated urine may have a yellow color, the simulated sweat and tears may be translucent, and the simulated bile may have a greenish-yellow color.

To provide a more realistic simulation, some or all of the components of the fluid delivery system 102 may be disposed remotely from the patient simulation manikin 135. For example, the tubing 130a-130g around the patient simulation manikin 135 and proximate the injury site is preferably hidden or concealed from the trainee. Thus, a portion of the tubing 130a-130g may be disposed internal to the patient simulation manikin 135, or may run along a sub-surface of the patient simulation manikin 135 (e.g., under an overlay of an injury overlay kit). This may, at least temporarily, create the suspension of disbelief, i.e., suspend the trainee's belief that the simulated injury is not real.

Other components of the fluid delivery system 102 may be located under a table or bed, for example, that is used to support the patient simulation manikin 135. Alternatively, the components may be located in another room, such as a control room, and portions of the tubing 130a-130g may be routed from the fluid delivery system 102 to the patient simulation manikin 135 under the floors, behind the walls, within a conduit, and/or via any other suitable means for concealing the tubing 130a-130g from view by the trainee. Moreover, as will be further discussed below, the flow of the simulated bodily fluids from the fluid delivery system 102 to the patient simulation manikin 135 may be controlled remotely, i.e., from another room or even from any location within the room that cannot be readily observed by the trainee. Thus, during the training exercise, the trainee may not be aware of the existence of the fluid delivery system 102, much less be able to anticipate when or where the simulated bodily fluids are to be delivered by observing the actions of the operator of the fluid delivery system 102, or by observing the simulated bodily fluids flowing to the patient simulation manikin 135.

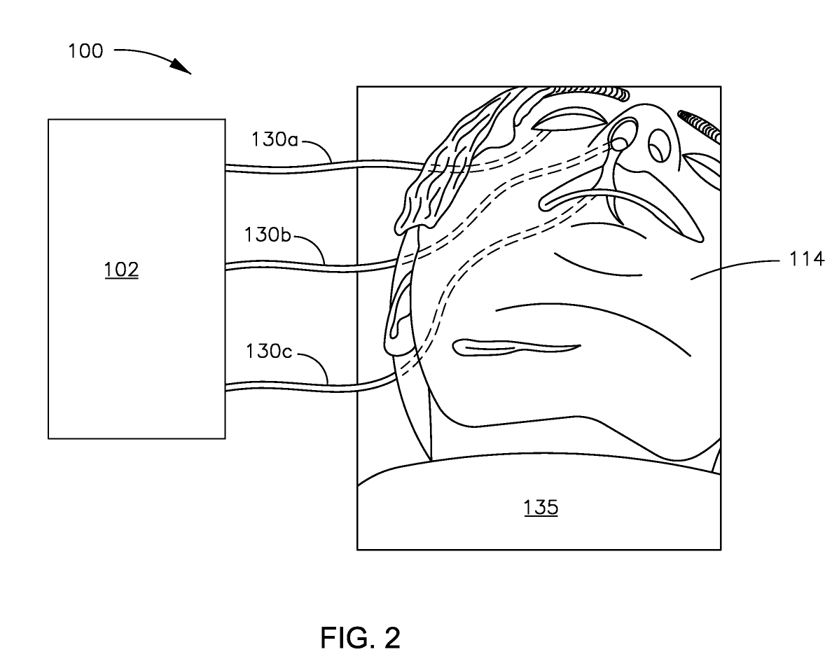

FIG. 2 shows the head 114 of the patient simulation manikin 135 connected to the fluid delivery system 102. As noted above, the tubing 130a-130c may be connected to the eyes, nose, and throat/mouth, respectively, of the head 114, though it will be appreciated that the tubing 130a-130c may be connected to other portions or areas of the head 114, such as one or both of the ears. Thus, in one embodiment, the tubing 130a may carry fluid simulating tears from the fluid delivery system 102 to one or both of the eyes. In addition, the tubing 130b may carry fluid simulating blood to the nose, and the tubing 130c may carry fluid simulating vomit to the throat/mouth. The simulated tears, blood and vomit may then be released or discharged from the corresponding openings in the patient simulation manikin 135 via internal or hidden tubing 130a-130c.

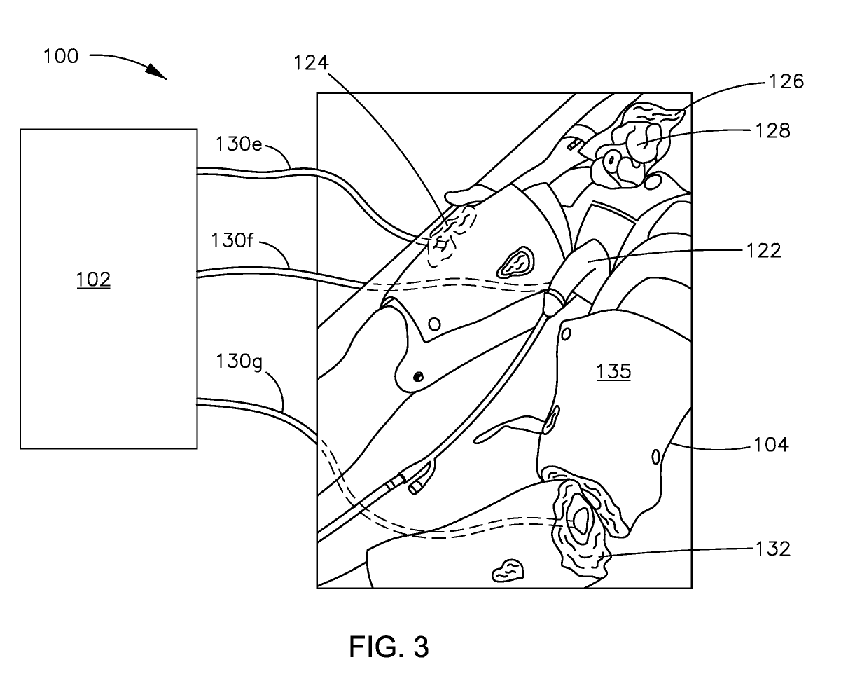

FIG. 3 shows the legs 104 and the torso 116 of the patient simulation manikin 135 connected to the fluid delivery system 102. As noted above, the tubing 130e and 130g may be connected to the legs 104, and the tubing 130f may be connected to the genitalia 122. Thus, in one embodiment, the tubing 130e and 130g may carry fluid simulating blood from the fluid delivery system 102 to the open wound 124 and the amputated leg 132, respectively, and the tubing 130f may carry fluid simulating urine to the genitalia 122. The simulated blood and urine may then be released or discharged from the corresponding portion of the patient simulation manikin 135. It will be appreciated that simulated blood may also be delivered to the genitalia 122 to simulate bleeding from the groin area.

Using the fluid delivery system 102, the trainer is generally able to control when and where the simulated bodily fluids are to be discharged from the patient simulation manikin 135 to provide more realistic simulations of physiological responses. For example, in one embodiment, the trainee may insert a catheter into the genitalia 122 during a training exercise. Rather than allowing the simulated urine to be discharged from the genitalia 122 immediately after the insertion of the catheter, the fluid delivery system 102 may be used to deliver the simulated urine at a desired time, such as when the trainee administers a drug that typically results in urine production. Moreover, rather than allowing the simulated urine to flow from the genitalia 122 at an uncontrolled rate, the fluid delivery system 102 may be used to control the flow rate and/or pressure to simulate the flow of actual urine. Thus, during the training exercise, the trainee is exposed to real physiological responses based on the trainee's actions.

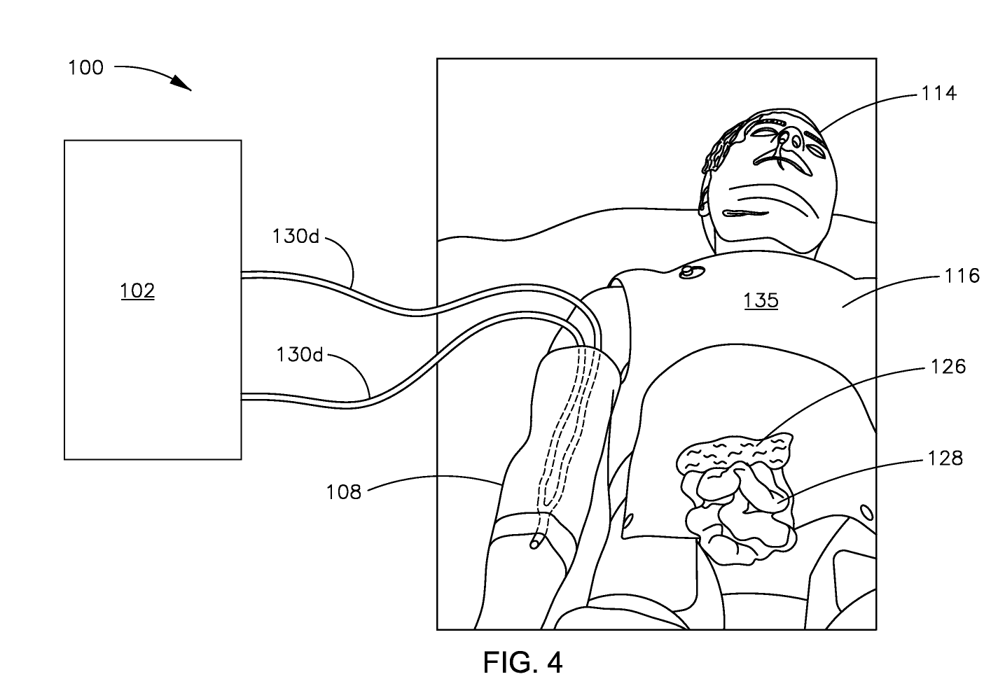

FIG. 4 shows one of the arms 108 of the patient simulation manikin 135 connected to the fluid delivery system 102. An overlay 109 from the injury overlay kit may be placed over the arm 108 to simulate human skin. As noted above, the tubing 130d may connect the fluid delivery system 102 to the arm 108, and may deliver simulated blood, for example. As shown in FIG. 4, a portion of the tubing 130d may extend under the overlay 109 to simulate veins. The tubing 130d may include a supply side that runs from the fluid delivery system 102 to the arm 108 to deliver the simulated blood to the patient simulation manikin 135. The tubing 130d may also include a return side that runs from the arm 108 to the fluid delivery system 102 to return the simulated blood to a reservoir or drainage bag. Thus, during a training exercise, a trainee may practice drawing blood from the patient simulation manikin 135 by placing a syringe (not shown) into one of the simulated veins (i.e., the tubing 130d under the overlay 109) and extracting the simulated blood. The flow rate and/or pressure of the simulated blood in the tubing 130d may simulate “flashback” when the trainee punctures the tubing 130d with the syringe. Flashback is a typical physiological response exhibited by patients who are giving blood, and generally may serve an indication that the needle of the syringe was successfully inserted into the vein.

In addition, the trainee may insert a needle into the simulated veins to practice delivering fluids intravenously. For example, the flow of simulated blood from the fluid delivery system 102 to the patient simulation manikin 135 may be shut-off. The trainee may then attach an intravenous (“IV”) bag to the tubing 130d in the arm 108 of the patient simulation manikin 135. The IV bag may hold intravenous fluids and/or any simulated liquid-based medications. The fluid in the IV bag may be delivered intravenously into the arm 108 and then exit the patient simulation manikin 135 via the return side of the tubing 130d. The fluid may then be collected in the reservoir or drainage bag of the fluid delivery system 102.

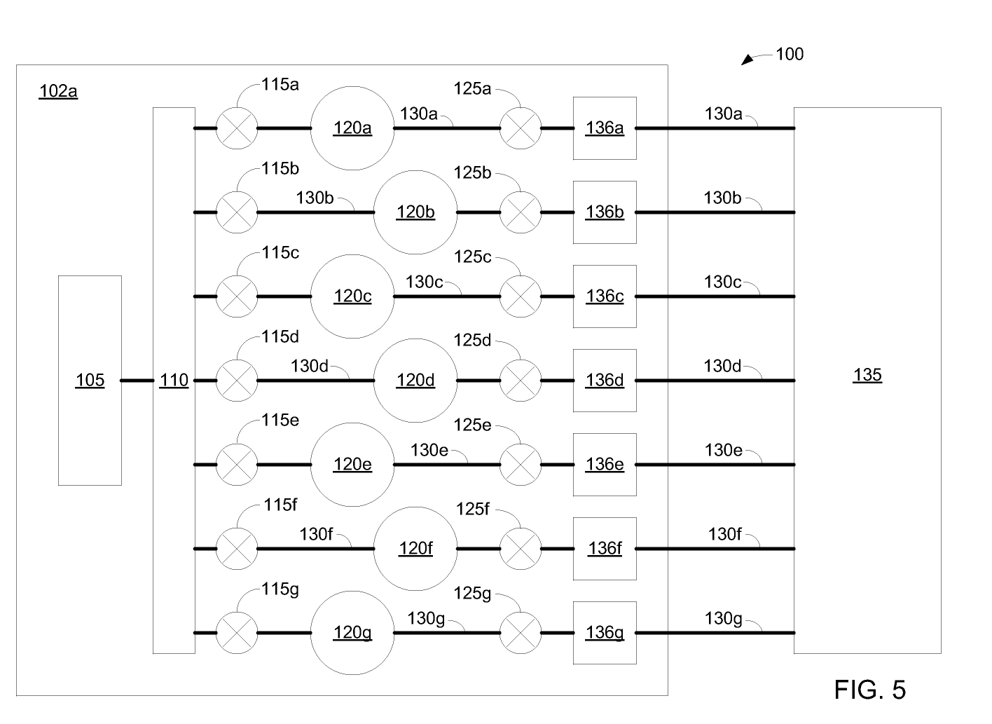

FIG. 5 is a system diagram of a fluid delivery system 102a according to one embodiment. The fluid delivery system 102a may include a fluid delivery component for causing the simulated bodily fluids to flow from multiple reservoirs (e.g., at least one reservoir for each body fluid being simulated) to the patient simulation manikin 135. For example, as shown in FIG. 5, the fluid delivery component may include a compressor 105, which may be connected to a manifold 110 via tubing 130. The compressor 105 may be any manually or electrically operated device or air source (e.g., a medical air feed) that supplies pressurized gas (e.g., 16-20 psi) to the reservoirs 120a-120g. The compressor 105 may be stationary or portable. The compressor 105 and/or the manifold 110 may be disposed remotely from the patient simulation manikin 135. The pressurized gas may be supplied at any suitable pressure (e.g., about 16 psi). The manifold 110 may then distribute the pressurized gas to the reservoirs 120a- 120g, which may store each of the simulated bodily fluids. Thus, the manifold 110 may enable the fluid delivery system 102a to supply pressurized gas to each of the reservoirs 120a-120g using a single compressor. It will be appreciated that the compressor 105 may also be used to deliver pressurized gas directly to the patient simulation manikin 135 to simulate breathing, or air in the lungs. In addition, in other embodiments, the compressor 105 may be connected directly to each reservoir without the presence of the manifold 110.

As shown in FIG. 5, the fluid delivery system 102a may include inlet valves 115a-115g connected to the manifold 110 and the inlets of the reservoirs 120a- 120g via the tubing 130a-130g. The fluid delivery system 102a may also include outlet valves 125a-125g connected to the outlets of the reservoirs 120a-120g via the tubing 130a-130g. The inlet valves 115a-115g and the outlet valves 125a-125g may be disposed remotely from the patient simulation manikin 135. The inlet valves 115a-115g and the outlet valves 125a-125g may be actuated manually or automatically (e.g., pneumatically or electrically). It will be appreciated that the fluid delivery system 102a may include either the inlet valves 115a-115g, the outlet valves 125a-125g, or some combination thereof.

It will further be appreciated that the tubing 130a-130g may each include one or more sections for interconnecting the components of the fluid delivery system 102a. The tubing 130a-130g may carry any substance, such as a gas or liquid, to and from the interconnected components of the fluid delivery system 102a. Fittings may be used to connect the tubing to the various system components, as well as to connect different pieces of tubing together.

Each of the inlet valves 115a-115g and/or the outlet valves 125a-125g may be any suitable device for controlling the flow of the simulated bodily fluids from the reservoirs 120a-120g. The inlet valves 115a-115g and/or the outlet valves 125a-125g may be actuated so that some or all of the simulated bodily fluids are delivered to the patient simulation manikin 135 simultaneously. Alternatively, the inlet valves 115a-115g and/or the outlet valves 125a-125g may be actuated so that some or all of the simulated bodily fluids are delivered to the patient simulation manikin 135 successively. Preferably, the fluid delivery system 102 is designed and constructed so that multiple, different fluids may be delivered to the patient simulation manikin 135 either simultaneously and/or in series without change-out, or change-over, of any of the individual components of the fluid delivery system 102.

The inlet valves 115a-115g may control the flow of the simulated bodily fluids by controlling the amount of pressurized gas being supplied to the inlets of the reservoirs 120a-120g. A higher amount of pressurized gas may cause the simulated bodily fluids to flow from the outlets of the reservoirs 120a- 120g at a higher flow rate and/or higher pressure. Conversely, a lower amount of pressurized gas may cause the simulated bodily fluids to flow from the outlets of the reservoirs 120a- 120g at a lower flow rate and/or lower pressure.

The amount of pressurized gas being supplied to the reservoirs 120a-120g may be controlled by actuating (i.e., opening and closing) the valves 115a-115g. More specifically, no pressurized gas may be supplied to the reservoirs 120a-120g when the valves 115a-115g are completely closed, while the maximum amount of pressurized gas may be supplied when the valves 115a-115g are completely open. An intermediate amount of pressurized gas may be supplied to the reservoirs 120a-120g when the valves 115a-115g are in a semi-open or semi-closed position.

The outlet valves 125a-125g may control the flow of the simulated bodily fluids under a given amount of pressure supplied from the compressor 105. Like the inlet valves 115a-115g, the flow of the simulated bodily fluids from the reservoirs 120a-120g may be controlled by actuating the outlet valves 125a-125g. No simulated bodily fluids may flow from the reservoirs 120a-120g when the outlet valves 125a-125g are completely closed (even if pressurized gas is being supplied to the reservoirs 120a-120g), while the simulated bodily fluids may flow at a maximum rate and/or maximum pressure from the reservoirs 120a-120g when the valves 125a-125g are completely open. The simulated bodily fluids may flow from the reservoirs 120a-120g at an intermediate rate and/or intermediate pressure when the valves 125a-125g are in a semi-open or semi-closed position.

The inlet valves 115a-115g and/or the outlet valves 125a-125g may be actuated so that the simulated bodily fluids are delivered to, and discharged from, the patient simulation manikin 135 at a generally constant flow rate and/or pressure. The inlet valves 115a-115g and/or the outlet valves 125a-125g may also be actuated so that the simulated bodily fluids are delivered to, and discharged from, the patient simulation manikin 135 at a variable flow rate and/or pressure. Moreover, the inlet valves 115a-115g and/or the outlet valves 125a-125g may be actuated to simulate a pulsating activity. For example, the inlet valves 115a-115g and/or the outlet valves 125a-125g may be successively opened and closed to cause the simulated bodily fluids to be discharged from the patient simulation manikin 135 intermittently. Alternatively, a pulsating device (not shown) may be used to simulate a pulsating fluid (e.g., a heart pumping blood). For example, an actuator may be attached to the tubing 130a-130g that restricts the flow of a simulated bodily fluid intermittently.

The fluid delivery system 102a may include flow meters 136a-136g for measuring the flow rates of the simulated bodily fluids. If the measured flow rates indicate that too much or too little simulated bodily fluid is being delivered to the patient simulation manikin 135, the inlet valves 115a-115g and/or the outlet valves 125a-125g and/or operation of the fluid delivery component (e.g., the compressor) may be adjusted accordingly by the trainer.

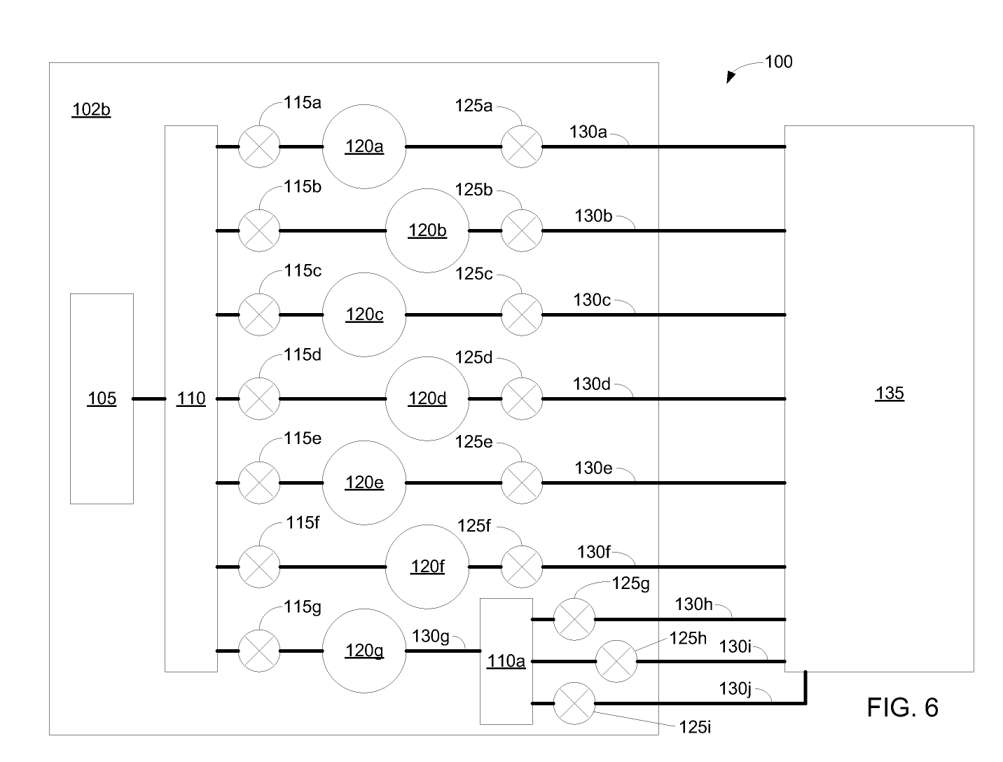

FIG. 6 is a system diagram of a fluid delivery system 102b according to another embodiment. The fluid delivery system 102b shown in FIG. 6 generally includes many of the same or similar components as the fluid delivery system 102a shown in FIG. 5. Unlike the fluid delivery system 102a, the fluid delivery system 102b may include a manifold 110a connected to the outlet of the reservoir 120g, though it will be appreciated that the manifold 110a or another manifold may be connected to any of the reservoirs 120a-120g. The manifold 110a may receive simulated blood, for example, from the reservoir 120g and distribute it to different portions of the patient simulation manikin 135 via tubing 130h-130j. The fluid delivery system 102b may also include outlet valves 125g-125i connected to the manifold 110a, though any number of valves may be used. The valves 125g-125i may be actuated to control the flow of the simulated blood from the reservoir 120g to the different portions/parts of the patient simulation manikin 135. For example, the tubing 130h-130j may carry the simulated blood to the legs 104, the arms 108, and the torso 116, respectively. Moreover, the valves 125g-125i may be used to individually adjust the flow rate and/or pressure of the simulated blood to the legs 104, the arms 108 and the torso 116.

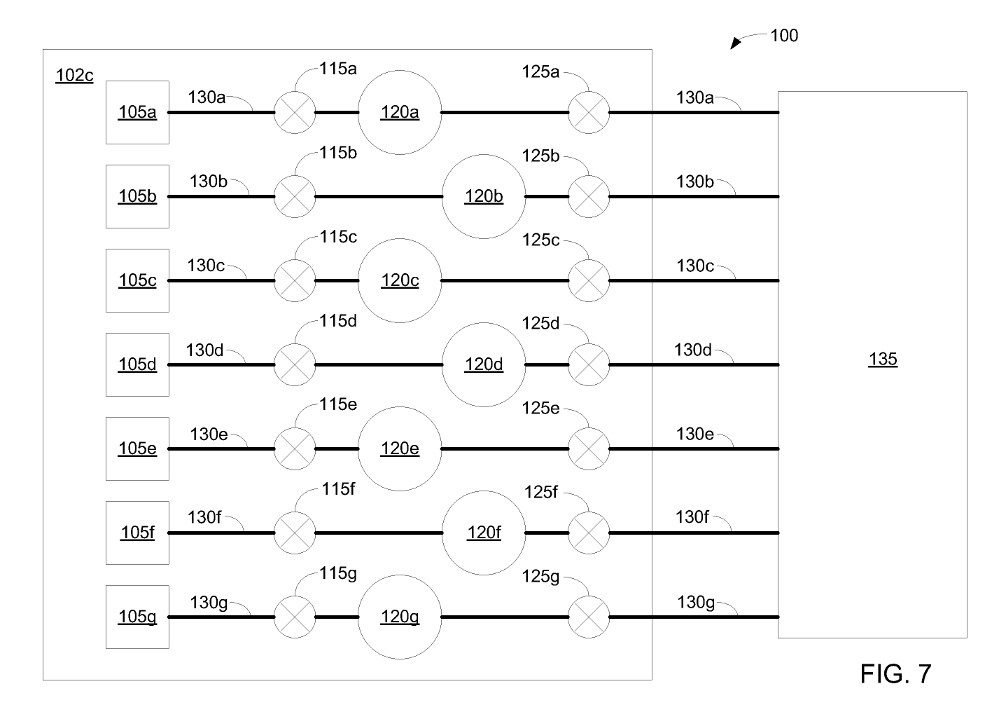

FIG. 7 is a system diagram of a fluid delivery system 102c according to another embodiment. The fluid delivery system 102c shown in FIG. 7 generally includes many of the same or similar components as the fluid delivery system 102a shown in FIG. 5. Unlike the fluid delivery system 102a, the fluid delivery system 102c may not include the manifold 110 for distributing pressurized gas to the reservoirs 120a-120g. Instead, the fluid delivery system 102c may include multiple compressors, such as compressors 105a-105g. Each of the compressors 105a-105g may be separately connected to one of the reservoirs 120a-120g via the respective tubing 130a-130g. Thus, if one of the compressors 105a-105g should fail, simulated bodily fluids may still be delivered to the patient simulation manikin 135 using one or more of the other functioning compressors. Moreover, the amount of pressurized gas being supplied to the each of the reservoirs 120a-120g may be separately controlled by adjusting one of the compressors 105a-105g. For example, the pressure being supplied to the reservoir 120a may be controlled by adjusting the output of the compressor 105a.

FIG. 8A is a system diagram of a fluid delivery system 102d according to yet another embodiment. In addition to the compressor 105, the manifold 110, the inlet valves 115a-115g, the reservoirs 120a-120g, and the outlet valves 125a-125g described above, the fluid delivery system 102d may also include an electronic controller 140. The electronic controller 140 may be electrically connected to the inlet valves 115a-115g, the outlet valves 125a-125g, the compressor 105, and/or the flow meters 136a-136g. The electronic controller 140 may be used to automatically and/or remotely actuate the inlet valves 115a- 15g and the outlet valves 125a-125g. In addition, the electronic controller 140 may be used to automatically and/or remotely power-on/power-off the compressor 105, and to automatically and/or remotely control the amount of pressurized gas being supplied by the compressor 105. The electronic controller 140 may also be used to monitor and record the flow rates measured by the flow meters 145a-145g.

FIG. 8B is a system diagram of the electronic controller 140 according to an embodiment. The electronic controller 140 may be a special or general purpose computing device. The electronic controller 140 may include a computer 210, a monitor 291 and other input or output devices, such as a mouse 261, a keyboard 262 and a modem 272.

The computer 210 may include a central processing unit 220, a system memory 230 and a system bus 221 that couples various system components including the system memory 230 to the central processing unit 220.

The system memory 230 may include computer storage media in the form of volatile and/or nonvolatile memory, such as ROM 231 and RAM 232. A basic input/output system 233 (BIOS) having the basic routines that help to transfer information between elements within the computer 210, such as during start-up, may be stored in the ROM 231. The RAM 232 may include data and/or program modules that are immediately accessible to and/or presently being operated on by the central processing unit 220. The system memory 230 additionally may include an operating system 234, application programs 235, other program modules 236, and program data 237.

The disclosed embodiments may be implemented in the electronic controller 140 in the form of any of a variety of computer readable media. Computer readable media can be any tangible media that can be accessed by the computer 210, including both volatile and nonvolatile, removable and non-removable media.

Computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210. The logical connections depicted in FIG. 8B include a local area network (“LAN”) 271 and a wide area network (“WAN”) 273, but may also include other networks. Such networking environments may be common in offices, enterprise-wide computer networks, intranets, and the Internet.

When used in a LAN networking environment, the computer 210 may be connected to the LAN 271 through a network interface 270. When used in the WAN 173 networking environment, the computer 210 may include the modem 272 for establishing communications over the WAN 173, such as the Internet. The modem 272 may be connected to the system bus 121 via a user input interface 260, or other appropriate mechanism.

The computer 210 may be deployed as part of a computer network. In this regard, various embodiments pertain to any computer system having any number of memory or storage units, and any number of applications and processes occurring across any number of storage units or volumes. An embodiment may apply to an environment with server computers and client computers deployed in a network environment, having remote or local storage. An embodiment may also apply to a standalone computing device, having programming language functionality, interpretation and execution capabilities.

The central processing unit 220 of the electronic controller 140 may execute one or more application programs 235, such as training program modules, which may include computer-executable instructions that are configured to implement predetermined clinical scenarios simulating certain injuries. The training program modules may be embodied in any tangible media, such as floppy diskettes, CD-ROMs, hard drives, or any other machine-readable storage medium that may be loaded into and executed by the central processing unit of the electronic controller 140. The training program modules may be implemented in a high-level procedural or object oriented programming language, or in assembly or machine language.

In one embodiment, the training program modules may include computer-executable instructions that, when executed by the central processing unit 220, cause the electronic controller 140 to output a signal to actuate the compressor 105, the inlet valves 115a-115g, and/or the outlet valves 125a-125g at predetermined times and/or at predetermined milestones to cause one or more of the simulated bodily fluids to flow to the patient simulation manikin 135 at predetermined flow rates and/or pressures. The predetermined training scenarios may simulate various types of injuries, such as gun-shot wounds to the chest or severe trauma to the head.

For example, the electronic controller 140 may actuate the inlet valves 115a-115g and/or the outlet valves 125a-125g at a predetermined time to cause simulated blood to be discharged from the simulated gun-shot wound at an initial, predetermined flow rate and/or pressure. As the patient simulation continues to lose simulated blood over the course of the training exercise (which may be monitored by the electronic controller 140 via one or more of the flow meters 136a-136g), the electronic controller 140 may then adjust the inlet valves 115a-115g and/or the outlet valves 125a-125g at another predetermined time to lower the flow rate and/or pressure of the simulated blood being discharged from the gun-shot wound to simulate the loss of blood pressure. At yet another predetermined time, the electronic controller may then adjust the inlet valves 115a-115g and/or the outlet valves 125a-125g to deliver an appropriate simulated bodily fluid to simulate the patient simulation manikin 135 going into shock. It will be appreciated that the delivery sequence and flow rate of the simulated bodily fluids, as well as the type of simulated bodily fluids being delivered, may be automatically controlled by the fluid delivery system 102d to replicate any desired clinical scenario.

In addition, the electronic controller 140 may receive user inputs during the execution of a training program module to manually adjust the amount or timing of the simulated bodily fluids being delivered to the patient simulation manikin 135. For example, when observing the trainee during the training exercise, the trainer may conclude that the trainee is not applying sufficient pressure to the gun-shot wound. As a result, the trainer may input commands to the electronic controller 140 to lower the flow rate and/or pressure of the simulated blood being delivered to the patient simulation manikin, thereby providing a realistic physiological response (e.g., loss of blood pressure) based on the trainee's actions (e.g., failure to provide adequate pressure to a bleeding wound).

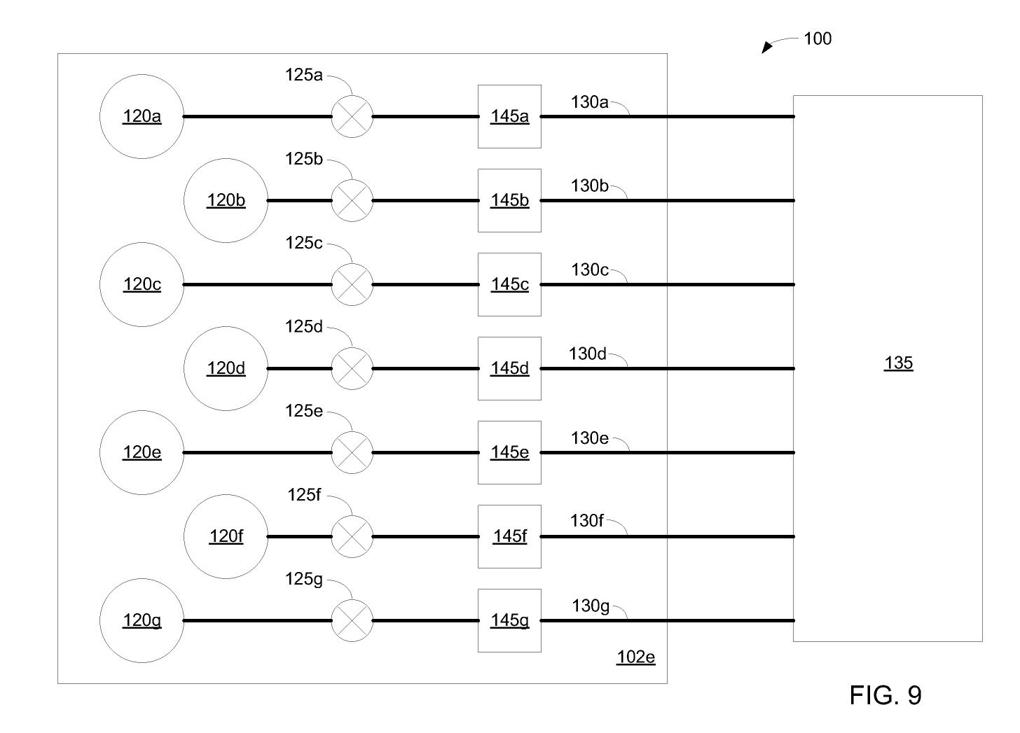

FIG. 9 is a system diagram of a fluid delivery system 102e according to another embodiment. Like the fluid delivery system 102a, the fluid delivery system 102e may include a fluid delivery component for causing to simulated bodily fluids to flow from one or more reservoirs to the patient simulation manikin 135. However, instead of using the compressor 105 for the fluid delivery component, the fluid delivery system 102e may include pumps 145a-145g, which may draw the simulated bodily fluids from the reservoirs 120a-120g and deliver the simulated bodily fluids to the patient simulation manikin 135. The pumps 145a-145g may be manually or automatically (e.g., pneumatically or electrically) operated. The fluid delivery system 102e may also include the valves 125a-125g located between the reservoirs 120a-120g and pumps 145a-145g to control the flow of the simulated bodily fluids from the reservoirs 120a-120g. In alternate embodiments, the flow of the simulated bodily fluids from each of the reservoirs 120a-120g may be controlled directly by the pumps 145a-145g. In another alternate embodiment, valves (not shown) may be located between the pumps 145a-145g and the patient simulation manikin 135.

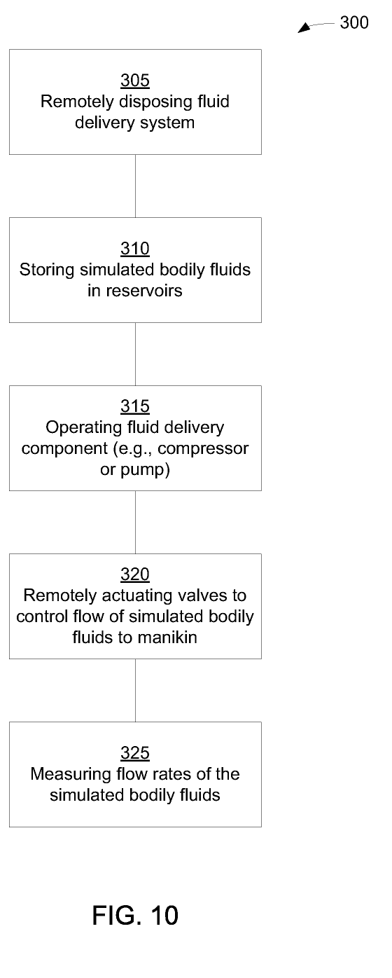

FIG. 10 is a flow diagram of an exemplary method 300 for remotely controlling the flow of the simulated bodily fluids to the patient simulation manikin 135. At 305, some or all of the components of the fluid delivery system 102 may be disposed remotely from the patient simulation manikin 135. For example, the reservoirs 120a-120g, the compressor 105, the inlet valves 115a-115g, and/or the outlet valves 125a-125g may be set-up in a control room that is separate from a training room, which may be used to conduct the training exercises. In addition, the tubing 130a-130g may be routed from the control room to the patient simulation manikin 135 under the floor, behind the walls, or otherwise concealed, and portions of the tubing 130a-130g may be routed within the patient simulation manikin 135. At 310, the simulated bodily fluids may be stored in the reservoirs 120a-120g. The simulated bodily fluids may include simulated blood, tears, sweat, vomit, bile, urine, spinal fluid, waste, and the like.

At 315, the fluid deliver component (e.g., the compressor 105) may be operated to cause the simulated bodily fluids to flow from the reservoirs 120a-120g to the patient simulation manikin 135. For example, the compressor 105 may be turned-on to deliver pressurized gas to the reservoirs 120-120g. At 320, the inlet valves 115a-115g and/or the outlet valves 125a-125g may be actuated remotely (by a trainer or by the electronic controller 140) from the patient simulation manikin 135 to control the flow rate and/or pressure of the simulated bodily fluids. Thus, the remote location of the fluid delivery system components, as well as the remote actuation of one or more components of the fluid delivery system 102, may prevent a trainee from anticipating when or where the simulated bodily fluids will be discharged from the patient simulation manikin 135.

The inlet valves 115a-115g and/or the outlet valves 125a-125g may be remotely actuated at predetermined times, as part of a predetermined training scenario, to cause the simulated bodily fluids to flow to the patient simulation manikin 135 at predetermined flow rates and/or pressures. For example, as noted above, a predetermined training scenario may be configured to simulate a patient with gun shot wounds to the chest. In such a scenario, simulated blood may be delivered to the torso 116 at a certain time and at a certain flow rate and/or pressure to simulate bleeding from the gun shot wounds.

The predetermined training scenario may be implemented manually, e.g., an operator may actuate the inlet valves 115a-115g and/or the outlet valves 125a-125g at the predetermined times. The predetermined training scenario may also be implemented automatically, e.g., by executing the appropriate training program module on the electronic controller 140. Moreover, the implementation of the predetermined training scenario may include some combination of the two.

At 325, the flow rates of the simulated bodily fluids may be monitored. The flow rates may be monitored via flow meters 136a-136g. The flow rates may also be visually monitored by observing the amount of simulated bodily fluids being discharged or released from the patient simulation manikin 135. The flow of the simulated bodily fluids may be adjusted via the inlet valves 115a-115g and/or the outlet valves 125a-125g in order to achieve a desired flow rate and/or pressure.

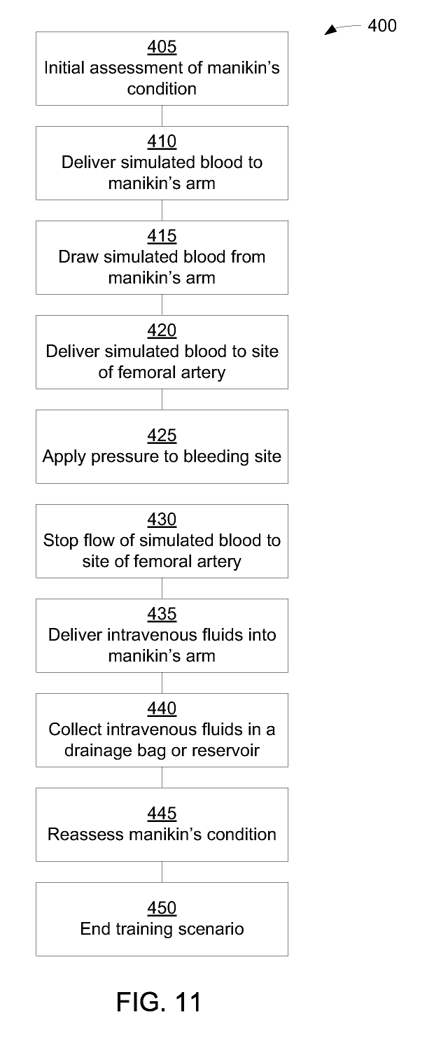

FIG. 11 is a flow diagram of an exemplary predetermined training scenario 400, which may simulate a patient with femoral artery hematoma, pseudoaneurysm, and subsequent bleeding. At 405, a trainee may make an initial assessment of the condition of the patient simulation manikin 135. For example, the trainee may outline the size of the hematoma around the femoral artery and perform an auscultation of the patient's circulatory system to determine if there is a bruit. At 410, the fluid delivery system 102 may be actuated to begin delivering simulated blood to the patient simulation manikin 135. For example, the fluid delivery system 102 may deliver simulated blood to one of the arms 108 via the tubing 130d. At 415, the trainee may attempt to draw blood from the patient simulation manikin 135 by inserting a needle into the tubing 130d at the arm 108. The flow rate and/or pressure of the simulated blood being delivered by the fluid delivery system 102 may simulate “flashback,” which may provide positive reinforcement to the trainee that the needle was properly inserted.

At 420, the fluid delivery system 102 may be actuated to begin delivering simulated blood to the site of the femoral artery on the patient simulation manikin 135. The simulated blood may then be discharged from the patient simulation manikin 135 at the site of the femoral artery. At 425, the trainee may immediately begin applying pressure to the bleeding site in an attempt to stop the bleeding. At 430, upon observing the trainee's attempt to apply pressure to the site of the bleeding, an operator of the fluid delivery system 102 may stop the flow of simulated blood to the site of the femoral artery, thereby providing positive reinforcement to the trainee that he or she was successful in stopping the bleeding.

At 435, the trainee may insert another needle into the tubing 130d to begin delivering fluids intravenously. At 440, the inserted intravenous fluids may be routed to the fluid delivery system 102 from the patient simulation manikin 135 via the return portion of the tubing 130d. The returned intravenous fluids may be collected in a drainage bag or reservoir in the fluid delivery system 102. At 445, the trainee may again assess the condition of the patient simulation manikin 135 to determine whether further action is need. At 450, the training scenario 400 may be terminated and the trainee evaluated based on his or her performance.

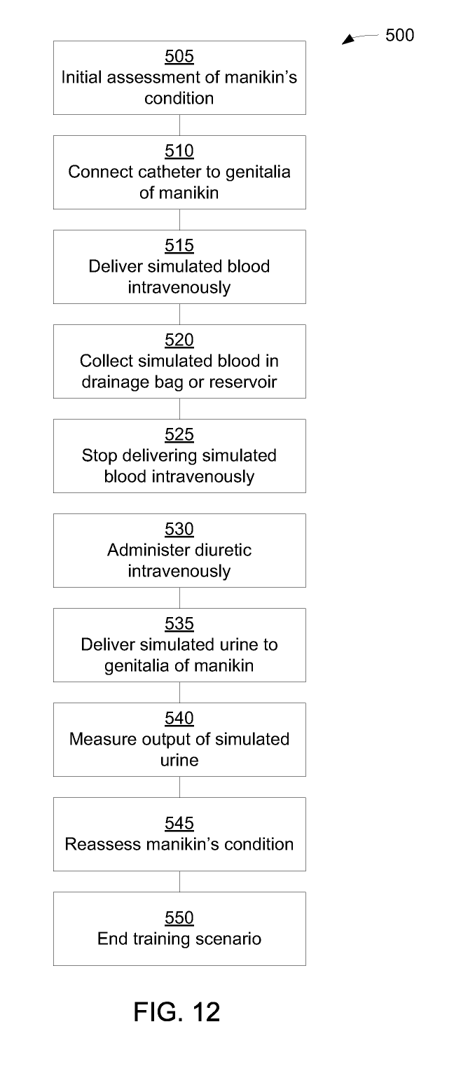

FIG. 12 is a flow diagram of an exemplary predetermined training scenario 500, which may simulate a patient exhibiting acute heart failure with pulmonary edema. At 505, a trainee may make an initial assessment of the condition of the patient simulation manikin 135. At 510, the trainee may connect a catheter to the genitalia 122, which may be connected to the fluid delivery system 102 via the tubing 130f. At 515, the trainee may insert a needle into the tubing 130d to begin delivering fluids, such as simulated blood, to the patient simulation manikin 135 intravenously. At 520, the simulated blood that is being inserted intravenously may be routed to the fluid delivery system 102 from the patient simulation manikin 135 via the return portion of the tubing 130d.

At 525, the trainee may stop delivering the simulated blood to the patient simulation manikin 135 intravenously. At 530, the trainee may begin administering a diuretic medication to the patient simulation manikin 135 intravenously. At 535, to simulate the physiological response of a patient receiving a diuretic, the fluid delivery system 102 may be actuated to begin delivering simulated urine to the genitalia 122 via the tubing 130f. The simulated urine may be discharged from the genitalia 122 into the catheter. The fluid delivery system 102 may deliver the simulated urine to the patient simulation manikin 135 at a particular flow rate and/or pressure to cause the simulated urine to be discharged into the catheter at a desired rate. For example, the fluid delivery system 102 may deliver the simulated urine at a low flow rate and/or pressure to indicate that the administered diuretic is not having its intended effect. Alternatively, the fluid delivery system 102 may deliver the simulated urine at a higher flow rate and/or pressure to indicate that the diuretic is working as intended. At 540, the trainee may measure the output of the simulated urine from the patient simulation manikin 135 to assess the effectiveness of the administered diuretic. At 545, the trainee may reassess the condition of the patient simulation manikin 135 to determine whether any further action is necessary. At 550, the training scenario 500 may be terminated and the trainee evaluated based on his or her performance.

Although illustrated and described herein with reference to certain specific embodiments, it will be understood by those skilled in the art that the invention is not limited to the embodiments specifically disclosed herein. Those skilled in the art also will appreciate that many other variations for the specific embodiments described herein are intended to be within the scope of the invention as defined by the following claims.

What is claimed:

1. A fluid delivery system for remotely controlling the flow of simulated bodily fluids to a patient simulation manikin, the system comprising:
a plurality of reservoirs for holding a plurality of simulated bodily fluids;
a plurality of valves for controlling the flow of the plurality of simulated bodily fluids from the plurality of reservoirs;
a fluid delivery component for causing the plurality of simulated bodily fluids to flow from the plurality of reservoirs to the patient simulation manikin, wherein at least one of the plurality of valves or the fluid delivery component is configured to be controlled remotely from the patient simulation manikin; and
a plurality of tubing for interconnecting the plurality of reservoirs, the fluid delivery component, the plurality of valves, and the patient simulation manikin to one another.

2. The fluid delivery system of claim 1, wherein the plurality of reservoirs, the plurality of valves, the fluid delivery component, and the plurality of tubing are disposed remotely from the patient simulation manikin.

3. The fluid delivery system of claim 1, wherein the fluid delivery component includes a compressor for supplying pressurized gas to a first reservoir of the plurality of reservoirs.

4. The fluid delivery system of claim 3, further comprising a manifold for distributing the pressurized gas from the compressor to the plurality of reservoirs.

5. The fluid delivery system of claim 1, wherein the fluid delivery component includes a pump for drawing at least one of the plurality of simulated bodily fluids from at least one of the plurality of reservoirs.

6. The fluid delivery system of claim 1, further comprising a manifold connected to an outlet of a first reservoir of the plurality of reservoirs, wherein the manifold is configured to distribute a first simulated bodily fluid of the plurality of simulated bodily fluids from the first reservoir to different portions of the patient simulation manikin.

7. The fluid delivery system of claim 6, further comprising a second plurality of valves connected to the manifold, wherein the second plurality of valves are configured to control the flow of the first simulated bodily fluid to the different portions of the patient simulation manikin, and
wherein the second plurality of valves are further configured to be controlled remotely from the patient simulation manikin.

8. The fluid delivery system of claim 1, further comprising an electronic controller for controlling at least one of the plurality of valves or the fluid delivery.

9. The fluid delivery system of claim 8, wherein the electronic controller is configured to actuate the plurality of valves at predetermined times.

10. The fluid delivery system of claim 8, wherein the electronic controller is configured to actuate the plurality of valves to cause the plurality of simulated bodily fluids to flow at predetermined flow rates.

11. The fluid delivery system of claim 1, further comprising a flow meter for measuring a flow rate of at least one of the plurality of simulated bodily fluids.

12. The fluid delivery system of claim 1, wherein two or more of the plurality of simulated bodily fluids are delivered to the patient simulation manikin simultaneously.

13. The fluid delivery system of claim 1, wherein two or more of the plurality of simulated bodily fluids are delivered to the patient simulation manikin successively.

14. The fluid delivery system of claim 1, wherein the plurality of simulated bodily fluids includes at least two of the following simulated fluids: blood, sweat, vomit, tears, bile, urine, stool, and spinal fluid.

15. A method for remotely controlling the flow of simulated bodily fluids to a patient simulation manikin, the method comprising:
storing a plurality of simulated bodily fluids in a plurality of reservoirs located remotely from the patient simulation manikin, wherein the plurality of reservoirs are connected to the patient simulation manikin via concealed tubing; and
actuating a fluid delivery system to control the flow of the simulated bodily fluids from the plurality of reservoirs to the patient simulation manikin via the concealed tubing, wherein the fluid delivery system is actuated remotely from the patient simulation manikin.

16. The method of claim 15, further comprising remotely disposing the plurality of reservoirs, the concealed tubing, a plurality of valves, and a fluid delivery component from the patient simulation manikin.

17. The method of claim 15, further comprising supplying pressurized gas to the plurality of reservoirs.

18. The method of claim 15, further comprising drawing the plurality of simulated bodily fluids from the plurality of reservoirs.

19. The method of claim 15, further comprising remotely controlling the flow of a first simulated bodily fluid of the plurality of simulated bodily fluids to different portions of the patient simulation manikin.

20. The method of claim 15, further comprising electronically actuating the fluid delivery system at predetermined times.

21. The method of claim 15, further comprising electronically actuating the fluid delivery system to cause the plurality of simulated bodily fluids to flow from the plurality of reservoirs at predetermined flow rates.

22. The method of claim 15, further comprising determining a flow rate of at least one of the plurality of simulated bodily fluids.

23. The method of claim 15, further comprising actuating the fluid delivery system so that the plurality of simulated bodily fluids are delivered to the patient simulation manikin simultaneously.

24. The method of claim 15, further comprising actuating the fluid delivery system so that the plurality of simulated bodily fluids are delivered to the patient simulation manikin successively.

25. A medical training system comprising:
a patient simulation manikin; and
a fluid delivery system comprising:
a plurality of reservoirs for holding a plurality of simulated bodily fluids;
a fluid delivery component for causing a first simulated bodily fluid of the plurality of simulated bodily fluids to flow from a first reservoir of the plurality of reservoirs;
a valve for controlling the flow of the first simulated bodily fluid from the first reservoir to the patient simulation manikin, wherein at least one of the valve or the fluid delivery component is configured to be controlled remotely from the patient simulation manikin; and
a plurality of tubing for interconnecting the plurality of reservoirs, the fluid delivery component, the valve, and the patient simulation manikin to one another, wherein the plurality of tubing is configured to be concealed at the patient simulation manikin.

26. The medical training system of claim 25, wherein the plurality of reservoirs, the fluid delivery component, and the valve are configured to be disposed remotely from the patient simulation manikin.

27. The medical training system of claim 25, wherein the fluid delivery component includes a compressor for supplying pressurized gas to the first reservoir.

28. The medical training system of claim 27, wherein the fluid delivery system further comprises a manifold connected to the compressor, wherein the manifold is configured to distribute the pressurized gas from the compressor to the plurality of reservoirs.

29. The medical training system of claim 25, wherein the fluid delivery component includes a pump for drawing the first simulated bodily fluid from the first reservoir.

30. The medical training system of claim 25, further comprising a manifold connected to an outlet of the first reservoir, wherein the manifold is configured to distribute the first simulated bodily fluid from the first reservoir to different portions of the patient simulation manikin.

31. The medical training system of claim 30, further comprising a plurality of valves connected to the manifold, wherein the plurality of valves are configured to control the flow of the first simulated bodily fluid to the different portions of the patient simulation manikin, and
wherein the plurality of valves are further configured to be controlled remotely from the patient simulation manikin.

32. The medical training system of claim 25, wherein the fluid delivery system further comprises an electronic controller for controlling at least one of the valve and the fluid delivery component at a predetermined time.

33. The medical training system of claim 25, wherein the fluid delivery system further comprises an electronic controller for controlling at least one of the valve or the fluid delivery component to cause the first simulated bodily fluid to flow at a predetermined flow rate.

34. The medical training system of claim 25, further comprising an injury simulation kit for simulating an injury on the patient simulation manikin.
